(19) United States
(12) Patent Application Publication
(10) Pub. No.: US 2014/0204253 A1
(43) Pub. Date: Jul. 24, 2014

(54) SOLID-STATE IMAGING DEVICE

(71) Applicant: Kabushiki Kaisha Toshiba, Minato-ku (JP)

(72) Inventors: Takahiko MIHARA, Kanagawa (JP); Yukiyasu Tatsuzawa, Kanagawa (JP); Tatsuji Ashitani, Kanagawa (JP); Yumi Yatsunami, Kanagawa (JP)

(73) Assignee: Kabushiki Kaisha Toshiba, Minato-ku (JP)

(21) Appl. No.: 13/946,493

(22) Filed: Jul. 19, 2013

(30) Foreign Application Priority Data
Jan. 22, 2013 (JP) 2013-009644

(51) Int. Cl. H04N 5/353

(52) U.S. Cl. CPC H04N 5/353
USPC 348/296

(57) ABSTRACT

According to one embodiment, a pixel array unit, an exposure period control unit, and a charge discharge control unit are provided. In the pixel array unit, pixels that accumulate photoelectrically converted charges are arranged in a matrix form. The exposure period control unit controls an exposure period of the pixels with respect to each of lines. The charge discharge control unit performs discharge control of charges accumulated in the pixels in a non-exposure period of the pixels with respect to each of lines.

### CROSS-REFERENCE TO RELATED APPLICATIONS

This application is based upon and claims the benefit of priority from Japanese Patent Application No. 2013-9644, filed on Jan. 22, 2013; the entire contents of which are incorporated herein by reference.

### FIELD

Embodiments described herein relate generally to a sold-state imaging device.

### BACKGROUND

In order to expand a dynamic range while maintaining sensitivity at low illumination, a solid-state imaging device alternately sets a line exposed for a short time and a line exposed for a long time, and synthesizes an image signal obtained from a pixel of the line exposed for a short time and an image signal obtained from a pixel of the line exposed for a long time.

### BRIEF DESCRIPTION OF THE DRAWINGS

FIG. 1 is a block diagram illustrating a schematic configuration of a solid-state imaging device according to a first embodiment;

FIG. 2 is a circuit diagram illustrating a configuration example of a pixel of the solid-state imaging device of FIG. 1;

FIG. 3A is a timing chart illustrating a voltage waveform of each unit of the pixel of FIG. 2 in a first exposure period, and FIG. 3B is a timing chart illustrating a voltage waveform of each unit of the pixel of FIG. 2 ire second exposure period;

FIG. 4A is a timing chart illustrating a PD charge amount in the first exposure period, FIG. 4B is a timing chart illustrating a PD charge amount in the second exposure period, and FIG. 4C is a timing chart illustrating a reset timing and a read timing of a pixel with respect to each of lines;

FIG. 5 is a block diagram illustrating a schematic configuration of an image processor that synthesizes signals read in the first exposure period and the second exposure period;

FIG. 6A is a timing chart illustrating a PD charge amount in a first exposure period of a solid-state imaging device according to a second embodiment, FIG. 6B is a timing chart illustrating a PD charge amount in a second exposure period of the solid-state imaging device according to the second embodiment, and FIG. 6C is a timing chart illustrating a reset timing and a read timing of a pixel of the solid-state imaging device according to the second embodiment.

### DETAILED DESCRIPTION

In general, according to one embodiment, a pixel array unit, an exposure period control unit, and a charge discharge control unit are provided. In the pixel array unit, pixels that accumulate photoelectrically converted charges are arranged in a matrix form. The exposure period control unit controls an exposure period of the pixels with respect to each of lines. The charge discharge control unit performs discharge control of charges accumulated in the pixels in a non-exposure period of the pixels with respect to each of lines.

Hereinafter, solid-state imaging device according to embodiments will be described in detail with reference to the accompanying drawings. Also, the present invention is not limited by these embodiments.

### First Embodiment

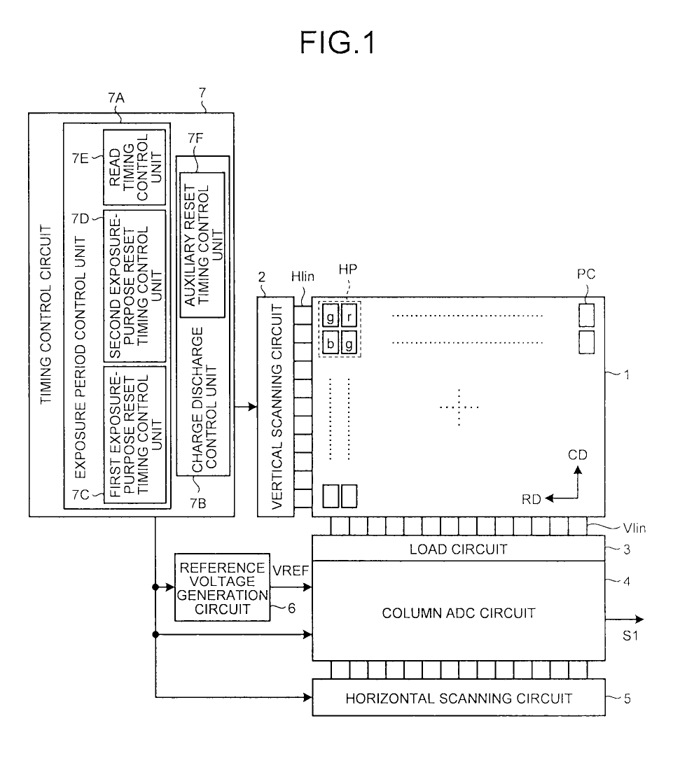

FIG. 1 is a block diagram illustrating a schematic configuration of a solid-state imaging device according to a first embodiment.

In FIG. 1, the solid-state imaging device includes a pixel array unit 1. In the pixel array unit 1, pixels PC configured to accumulate photoelectrically converted charges are arranged in a matrix form in a row direction RD and a column direction CD. Also, in the pixel array unit 1, horizontal control line Hlin configured to perform read control of the pixels PC are provided in the row direction RD, and vertical signal lines Vlin configured to transfer signals read from the pixels PC are provided in the column direction CD.

Also, the solid-state imaging device includes a vertical scanning circuit 2 configured to scan the pixels PC to be read in a vertical direction, a load circuit 3 configured to perform a source follower operation between the pixels PC to read signals from the pixels PC to the vertical signal lines Vlin with respect to each of columns, a column ADC circuit 4 configured to detect signal components of the respective pixels PC by CDS with respect to each of columns, a horizontal scanning circuit 5 configured to scan the pixels PC to be read in a horizontal direction, a reference voltage generation circuit 6 configured to output a reference voltage VREF to the column ADC circuit 4, and a timing control circuit 7 configured to control a read or accumulation timing of the respective pixels FC. Also, the reference voltage VREF may use a ramp wave.

Also, in the pixel array unit 1, a Bayer array NP may be formed with a pair of four pixels PC so as to colorize a captured image. In the Bayer array HP, two green pixels g are arranged in one diagonal direction, and one red pixel r and one blue pixel b are arranged in the other diagonal direction.

The timing control circuit 7 includes an exposure period control unit 7A and a charge discharge control unit 7B. The exposure period control unit 7A includes a first exposure-purpose reset timing control unit 7C, a second exposure-purpose reset timing control unit 7D, and a read timing control unit 7E. The charge discharge control unit 7B includes an auxiliary reset timing control unit 7F. The exposure period control unit 7A controls the exposure period of the pixels PC with respect to each of lines. The charge discharge control unit 7B performs discharge control of charges accumulated in the pixels PC in the non-exposure period of the pixels PC with respect to each of lines. The read timing control unit 7E controls a read timing of charges accumulated in the pixels PC. The first exposure-purpose reset timing control unit 7C controls a reset timing of charges accumulated in the pixels PC on a first line of the pixel array unit 1. The second exposure-purpose reset timing control unit 7D controls a reset timing of charges accumulated in the pixels PC on a second line such that the exposure period is shortened more than the exposure period in the pixels PC on the first line of the pixel array unit 1. The auxiliary reset timing control unit 7F controls a reset timing of charges accumulated in the pixels PC on the second line in the non-exposure period of the pixels PC on the second line of the pixel array unit 1. Also, the first line and the second line may be alternately set on the pixel array unit 1. For example, in the Bayer array HP, the first line may be set to (4n+1)th and (4n+2)th lines of the pixel array unit 1 (n is an integer equal to or greater than 0), and the second line may be set to (4n+3)th and (4n+4)th lines of the pixel array unit 1.

The vertical scanning circuit 2 scans the pixels PC in the vertical direction to select the pixels PC in the row direction RD. The load circuit 3 performs the source follower operation between the pixels PC, so that signals read from the pixels PC are transferred through the vertical signal lines Vlin and transferred to the column ADC circuit 4. Also, in the reference voltage generation circuit 6, the ramp wave is set as the reference voltage VREF and is transferred to the column ADC circuit 4. In the column ADC circuit 4, a clock count operation is performed until a signal level and a reset level read from the pixel PC are coincident with a level of the ramp wave. By taking a difference between the signal level and the reset level at that time, a signal component of each pixel PC is detected by CDS and is output as an output signal S1.

Herein, by controlling the reset timing of the charges accumulated in the pixels PC on the second line such that the exposure period is shortened more than the exposure period in the pixels PC on the first line of the pixel array unit 1, the sensitivity in the pixels on the first line can be increased as compared with the pixels on the second line. Therefore, the dynamic range can be improved by synthesizing the output signal S1 generated from the pixels PC on the first line and the output signal S1 generated from the pixels PC on the second line.

Also, by controlling the reset timing of the charges accumulated in the pixels PC on the second lines in the non-exposure period of the pixels PC on the second line of the pixel array unit 1, it is possible to reduce the charges accumulated in the pixels PC on the second line in the non-exposure period. Therefore, the charges accumulated in the pixels PC on the second line in the non-exposure period can be prevented from overflowing the pixels on the first line, and blooming can be reduced.

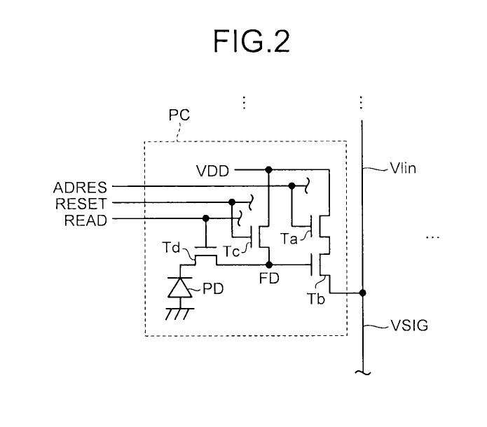

FIG. 2 is a circuit diagram illustrating a configuration example of the pixel of the solid-state imaging device of FIG. 1.

In FIG. 2, each of the pixels PC includes a photodiode PD, a row selection transistor Ta, an amplification transistor Tb, a reset transistor Tc, and a read transistor Td. Also, a floating diffusion FD as a detection node is formed at a connection point of the amplification transistor Tb, the reset transistor Tc, and the read transistor Td.

A source of the read transistor Td is connected to the photodiode PD, and a read signal READ is input to a gate of the read transistor Td. Also, a source of the reset transistor Tc is connected to a drain of the read transistor Td, and the reset signal RESET is input La a gate of the reset transistor Tc. A drain of the reset transistor Tc is connected to a power supply potential VDD. Also, a row selection signal ADRES is input to a gate of the row selection transistor Ta, and a drain of the row selection transistor Ta is connected to the power supply potential VDD. Also, a source of the amplification transistor Tb is connected to the vertical signal line Vlin, a gate of the amplification transistor Tb is connected to the drain of the read transistor Td, and a drain of the amplification transistor Tb is connected to a source of the row selection transistor Ta.

Also, the horizontal control line Hlin of FIG. 1 can transfer the read signal READ, the reset signal RESET, and the row selection signal ADRES to the pixel PC with respect to each of rows.

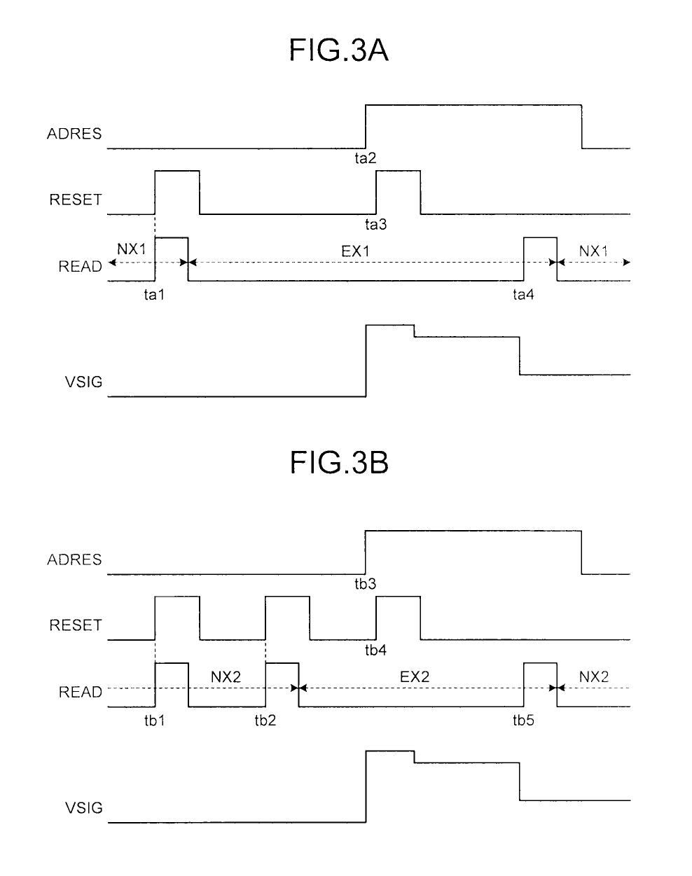

FIG. 3A is a timing chart illustrating a voltage waveform of each unit of the pixel of FIG. 2 in the first exposure period, and FIG. 3B is a timing chart illustrating a voltage waveform of each unit of the pixel of FIG. 2 in the second exposure period.

In FIG. 3A, the first exposure period EX1 is set to the pixels PC on the first line of the pixel array unit 1 of FIG. 1, and in FIG. 3B, the second exposure period EX2 is set to the pixels PC on the second line of the pixel array unit 1 of FIG. 1. The first exposure period EX1 is longer than the second exposure period EX2.

As illustrated in FIG. 3A, in the pixels PC on the first line, when the row selection signal ADRES is at a low level, the row selection transistor Ta becomes in an off state, and the pixel signal VSIG is not output to the vertical signal line Vlin. At this time, when the read signal READ and the reset signal RESET become a high level (ta1), the read transistor Td is turned on and charges accumulated in the photodiode PD in the first non-exposure period NX1 are discharged to the floating diffusion FD. Subsequently, the charges are discharged through the reset transistor Tc to the power supply VDD.

After the charges accumulated in the photodiode PD in the first non-exposure period NX1 are discharged to the power supply VDD, when the read signal READ becomes a low level, the photodiode PD starts to accumulate effective signal charges and changes from the first non-exposure period NX1 to the first exposure period EX1.

Subsequently, when the row selection signal ADRES becomes a high level (ta2), the row selection transistor Ta of the pixel PC is turned on, and the power supply potential VDD is applied to the drain of the amplification transistor Tb.

When the reset signal RESET becomes a high level in a state where the row selection transistor Ta is in an on state (ta3), the reset transistor Tc is turned on, and extra charges generated in a leakage current or the like at the floating diffusion FD are reset. The voltage corresponding to the reset level of the floating diffusion FD is applied to the gate of the amplification transistor Tb, and the voltage of the vertical signal line Vlin follows the voltage applied to the gate of the amplification transistor Tb. Therefore, the pixel signal VSIG of the reset level is output to the vertical signal line Vlin.

The pixel signal VSIG of the reset level is input to the column ADC circuit 4 and is compared with the reference voltage VREF. Based on the comparison result, the pixel signal VSIG of the reset level is converted into a digital value, and the digital value is held.

Subsequently, when the read signal READ becomes a high level in a state where the row selection transistor Ta of the pixel PC is in an on state (ta4), the read transistor Td is turned on, and the charges accumulated in the photodiode PD in the first exposure period EX1 are transferred to the floating diffusion FD. The voltage corresponding to the signal read level of the floating diffusion FD is applied to the gate of the amplification transistor Tb, and the voltage of the vertical signal line Vlin follows the voltage applied to the gate of the amplification transistor Tb. Therefore, the pixel signal VSIG of the signal read level is output to the vertical signal line Vlin.

The pixel signal VSIG of the signal reset level is input to the column ADC circuit 4 and is compared with the reference voltage VREF. Based on the comparison result, a difference between the pixel signal VSIG of the reset level and the pixel signal VSIG of the signal read level is converted into a digital value, and the digital value is output as the output signal S1 corresponding to the first exposure period EX1.

On the other hand, as illustrated in FIG. 3B, in the pixels PC on the second line, when the row selection signal. ADRES is at a low level, the row selection transistor Ta becomes in an off state, and the pixel signal VSIG is not output to the vertical signal line Vlin. At this time, when the read signal READ and the reset signal RESET become a high level (tb1), the read transistor Td is turned on, and the charges accumulated in the photodiode PD in the second non-exposure period NX2 are discharged to the floating diffusion FD. Subsequently, the charges are discharged through the reset transistor Tc to the power supply VDD.

After the charges accumulated in the photodiode PD in the second non-exposure period NX2 are discharged to the power supply VDD, when the read signal READ becomes a low level, the photodiode PD starts to accumulate effective signal charges in the second non-exposure period NX2.

Subsequently, when the read signal READ and the reset signal RESET become a high level again (tb2), the read transistor Td is turned on, and the charges accumulated in the photodiode PD in the second non-exposure period NX2 are discharged again to the floating diffusion VDD. Subsequently, the charges are discharged through the reset transistor Tc to the power supply VDD.

After the charges accumulated in the photodiode PD in the second non-exposure period NX2 are discharged again to the power supply VDD, when the read signal READ becomes a low level, the photodiode PD starts to accumulate effective signal charges and changes from the second non-exposure period NX2 to the second exposure period EX2.

Subsequently, when the row selection signal ADRES becomes a high level (tb3), the row selection transistor Ta of the pixel PC is turned on, and the power supply potential VDD is applied to the drain of the amplification transistor Tb.

When the reset signal RESET becomes a high level in a state where the row selection transistor Ta is in an on state (tb4), the reset transistor Tc is turned on, and extra charges generated in a leakage current or the like at the floating diffusion FD are reset. The voltage corresponding to the reset level of the floating diffusion FD is applied to the gate of the amplification transistor Tb, and the voltage of the vertical signal line Vlin follows the voltage applied to the gate of the amplification transistor Tb. Therefore, the pixel signal VSIG of the reset level is output to the vertical signal line Vlin.

The pixel signal VSIG of the reset level is input to the column ADC circuit 4 and is compared with the reference voltage VREF. Based on the comparison result, the pixel signal VSIG of the reset level is converted into a digital value, and the digital value is then held.

Subsequently, when the read signal READ becomes a high level in a state where the row selection transistor Ta of the pixel PC is in an on state (tb5), the read transistor Td is turned on, and the charges accumulated in the photodiode PD in the second exposure period EX2 are transferred to the floating diffusion FD. The voltage corresponding to the signal read level of the floating diffusion FD is applied to the gate of the amplification transistor Tb, and the voltage of the vertical signal line Vlin follows the voltage applied to the gate of the amplification transistor Tb. Therefore, the pixel signal VSIG of the signal read level is output to the vertical signal line Vlin.

The pixel signal VSIG of the signal reset level is input to the column ADC circuit 4 and is compared with the reference voltage VREF. Based on the comparison result, a difference between the pixel signal VSIG of the reset level and the pixel signal VSIG of the signal read level is converted into a digital value, and the digital value is output as the output signal S1 corresponding to the second exposure period EX2.

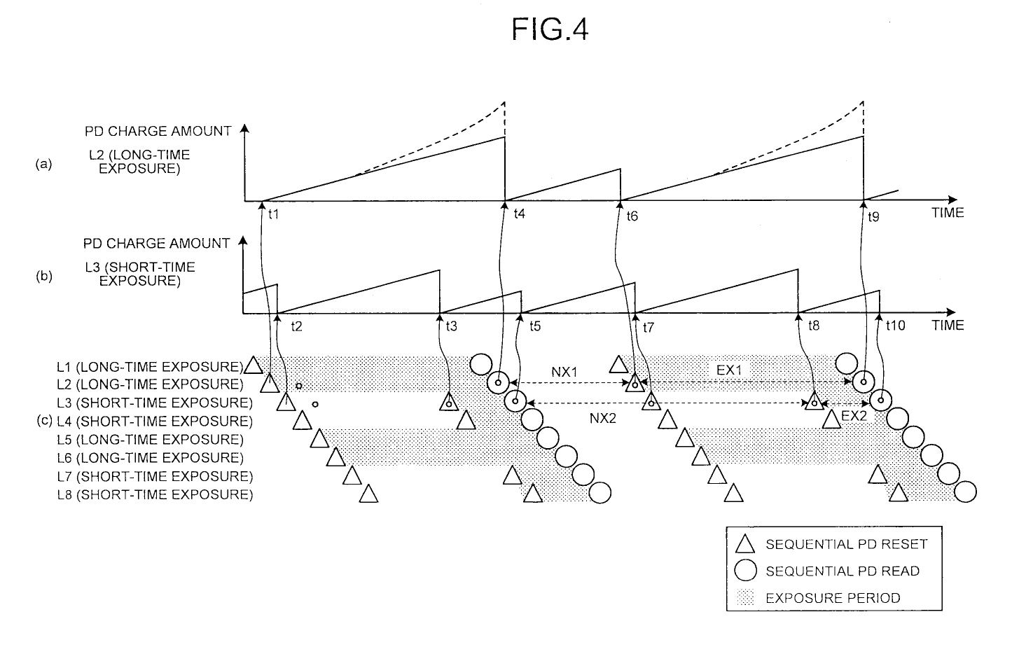

FIG. 4A is a timing chart illustrating a PD charge amount in the first exposure period, FIG. 4B is a timing chart illustrating a PD charge amount in the second exposure period, and FIG. 4C is a timing chart illustrating a reset timing and a read timing of a pixel with respect to each of lines. Also, the examples of FIGS. 4A to 4C illustrate a case where pixels PC form a Bayer array HP, and first lines (lines L1, L2, L5 and L6) and second lines (lines L3, L4, L7 and L8) are alternately set by every two lines.

In FIGS. 4A to 4C, the first exposure period EX1 and the first non-exposure period NX1 are set to the lines L1, L2, L5 and L6, and the second exposure period EX2 and the second non-exposure period NX2 are set to the lines L3, L4, L7 and L8.

For example, in the pixel PC of the line L2, the charges accumulated in the photodiode PD in the first non-exposure period NX1 are discharged (t1), and the period changes from the first non-exposure period NX1 to the first exposure period EX1. On the other hand, for example, in the pixel PC of the line L3, the charges accumulated in the photodiode PD in the second non-exposure period NX2 are discharged (t2), and the second non-exposure period NX2 maintained. Subsequently, in the pixel PC of the line L3, the charges accumulated in the photodiode PD in the second non-exposure period NX2 are discharged again (t3), and the period changes from the second non-exposure period NX2 to the second exposure period EX2.

Subsequently, in the pixel PC of the line L2, the charges accumulated in the photodiode PD in the first exposure period EX1 are read (t4), and the period changes from the first exposure period EX1 to the first non-exposure period NX1. On the other hand, in the pixel PC of the line L3, the charges accumulated in the photodiode PD in the second exposure period EX2 are read (t5), and the period changes from the second exposure period EX2 to the second non-exposure period NX2.

Likewise, in the pixel PC of the line L2, the charges accumulated in the photodiode PD in the first non-exposure period NX1 are discharged (t6), and the period changes from the first non-exposure period NX1 to the first exposure period EX1. On the other hand, in the pixel PC of the line L3, the charges accumulated in the photodiode PD in the second non-exposure period NX2 are discharged (t7), and the second non-exposure period NX2 is maintained. Subsequently, in the pixel PC of the line L3, the charges accumulated in the photodiode PD in the second non-exposure period NX2 are discharged again (t8), and the period changes from the second non-exposure period NX2 to the second exposure period EX2.

Subsequently, in the pixel PC of the line L2, the charges accumulated in the photodiode PD in the first exposure period EX1 are read (t9), and the period changes from the first exposure period EX1 to the first non-exposure period NX1. On the other hand, in the pixel PC of the line L3, the charges accumulated in the photodiode Pt) in the second exposure period EX2 are read (t10), and the period changes from the second exposure period EX2 to the second non-exposure period NX2.

When the first exposure period EX1 is longer than the second exposure period EX2, the second non-exposure period NX2 becomes longer than the first non-exposure period NX1. When the second non-exposure period NX2 becomes longer, the charge amount accumulated in the photodiode PD in the second non-exposure period NX2 increases. As a result, when the amount of light incident on the photodiode PD is large, the charges accumulated in the photodiode PD in the second non-exposure period NX2 overflows so that that the charges flow from the pixel PC on the line L3 to the pixel PC on the line L2. When the charges flow from the pixel PC on the line L3 to the pixel PC on the line L2, the charge amount of the pixel PC on the line L2 increases to generate blooming as indicated by dashed lines Therefore, the charges accumulated in the photodiode PD in the second non-exposure period NX2 are discharged from the photodiode PD in the second non-exposure period NX2 repetitively multiple times, which can reduce the charge amount accumulated in the photodiode PD in the second non-exposure period NX2 and can prevent the overflow of the charges accumulated in the photodiode PD in the second non-exposure period NX2.

Also, a time interval between the read timing of the pixel PC on the second line in the second exposure period EX2 (time point t7 in the line L3) and the reset timing of the pixel PC on the second line in the second non-exposure period NX2 (time point t5 in the line L3) can be equal La a time interval between the read timing of the pixel PC on the first line in the first exposure period EX1 (time point t6 in the line L2) and the reset timing of the pixel PC on the first line in the first exposure period EX1 (time point t4 in the line L2). In this way, the circuit configuration can be prevented from being complicated since a timing during which the charges are from the photodiode PD of the pixel PC on the second line in an auxiliary manner can be matched with a timing during which the charges are discharged from the photodiode PD of the pixel on the first line, and the control of these timings can be facilitated.

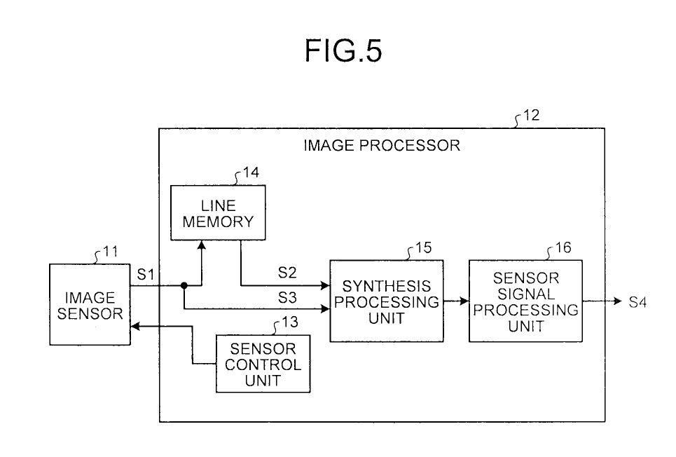

FIG. 5 is a block diagram illustrating a schematic configuration of an image processor that synthesizes signals read in the first exposure period and the second exposure period.

In FIG. 5, the image processor 12 includes a sensor control unit 13, a line memory 14, a synthesis processing unit 15, and a sensor signal processing unit 16. The image processor 12 is connected to an image sensor 11. Also, the image sensor 11 may use the configuration of FIG. 1.

The sensor control unit 13 generates a control signal according to user operation or the like, and supplies the control signal to each unit of the image sensor 11 such that the image sensor 11 is controlled to operate according to the user operation. Also, the sensor control unit 13 can control the image sensor 11 and, for example, can generate the output signals S1 of the long-time exposure on the first line and the short-time exposure on the second line.

The line memory 14 can separate the output signals S1 output from the image sensor 11 with respect to each of exposure periods, and output the same in synchronization with the timing of the output signals S1 with respect to each of exposure periods. The synthesis processing unit 15 can generate an image signal with an expanded dynamic range by synthesizing the output signals S1 of the long-time exposure and the short-time exposure. The sensor signal processing unit 16 can perform signal processing, such as white balance adjustment or demosaicing processing, image quality adjustment, and the like.

The line memory 14 stores, for example, the output signal S2 of the long-time exposure on the first line among output signals S1 of the long-time exposure on the first line and the short-time exposure on the second line. In a read timing of a next line, when the output signal S3 of the short-time exposure on the second line is output from the image sensor 11, the output signal S2 of the long-Lime exposure on the first line is read from the line memory 14 at the same time and is transferred to the synthesis processing unit 15. After the output signals S2 and S3 are synthesized in the synthesis processing unit 15, signal processing is performed by the sensor signal processing unit 16 to output the image signal S4 with an expanded dynamic range.

Also, in the above-described embodiment, there has been described a method that performs the discharging of the charges accumulated in the photodiode PD in the pixel PC on the first pixel only one time in the first non-exposure period NX1 and performs the discharging of the charges accumulated in the photodiode PD in the pixel. PC on the second line only two times in the second non-exposure period NX2. However, the discharging of the charges accumulated in the photodiode PD in the pixel PC on the second line can be performed three or more times in the second non-exposure period NX2, and the discharging of the charges accumulated in the photodiode PD in the pixel PC on the first line can be performed multiple times in the first non-exposure period NX1.

Also, in the above-described embodiment, there has been described a method that sets two different exposure times of the long-time exposure and the short-time exposure with respect to each of lines so as to expand the dynamic range. However, three different exposure times of the long-time exposure, the intermediate-time exposure, and the short-time exposure can be set with respect to each of lines, and four different exposure times may be set with respect to each of lines.

### Second Embodiment

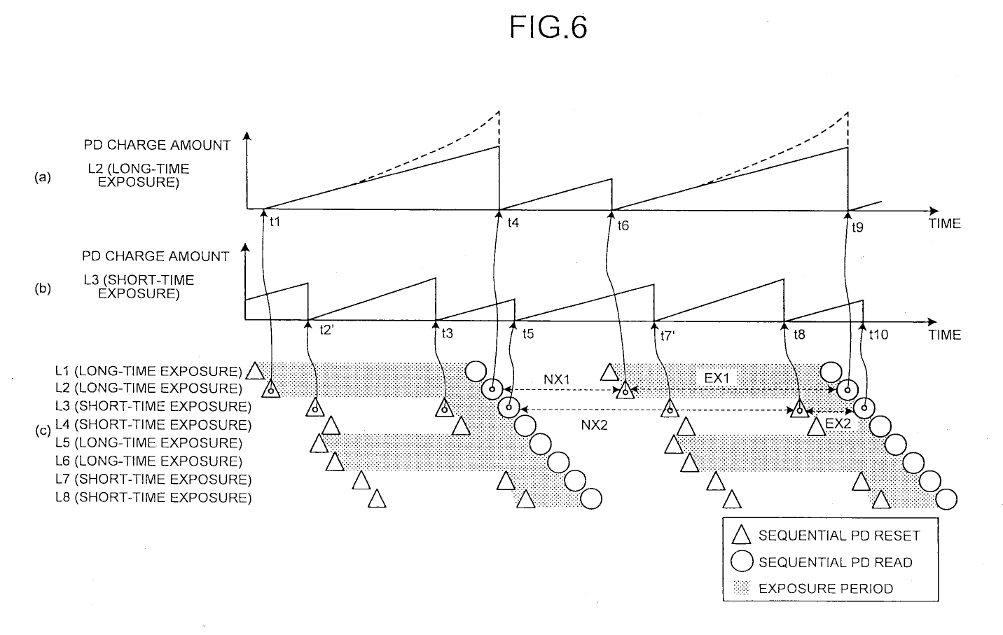

FIG. 6A is a timing chart illustrating a PD charge amount in a first exposure period of a solid-state imaging device according to a second embodiment, FIG. 6B is a timing chart illustrating a PD charge amount in a second exposure period of the solid-state imaging device according to the second embodiment, and FIG. 6C is a timing chart illustrating a reset timing and a read timing of a pixel of the solid-state imaging device according to the second embodiment with respect to each of lines.

In FIGS. 6A to 6C, in the second embodiment, a reset timing of a pixel PC on the second line in the second non-exposure period NX2 (time points t2′ and t7′ in a line L3) is set to the middle of the second non-exposure period NX2. That is, for example, in the line L3, an interval between a read timing t5 and a first-time PD reset timing t7′ is equal to an interval between a PD reset timing t7′ and a second-time PD reset timing t8. In this way, in the second non-exposure period NX2, a charge amount accumulated in the photodiode PD until each PD reset can be equalized, and a maximum value of the charge amount accumulated in the photodiode PD can be reduced. Therefore, it is possible to make it difficult for the charges accumulated in the photodiode PD to overflow.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A solid-state imaging device comprising:
a pixel array unit in which pixels configured to accumulate photoelectrically converted charges are arranged in a matrix form;
a vertical scanning circuit configured to scan the pixels in a vertical direction;
a horizontal scanning circuit configured to scan the pixels in a horizontal direction;
vertical signal lines configured to transfer pixel signals read from the pixels in a vertical direction;
a load circuit configured to perform a source follower operation between the pixels to read signals from the pixels to the vertical signal lines with respect to each of columns;
an exposure period control unit configured to control an exposure period of the pixels with respect to each of lines;
a charge discharge control unit configured to perform discharge control of charges accumulated in the pixels in a non-exposure period of the pixels with respect to each of lines; and
an image processor configured to synthesize signals, which are read from the pixels and of which the exposure periods are different from one another,
wherein the exposure period control unit comprises:
a read timing control unit configured to control a read timing of charges accumulated in the pixels;
a first exposure-purpose reset timing control unit configured to control a reset timing of charges accumulated in the pixels on the first line; and
a second exposure-purpose reset timing control unit configured to control a reset timing of charges accumulated in the pixels on the second line such that the exposure period is shortened more than the exposure period in the pixels on the first line,
wherein the charge discharge control unit includes an auxiliary reset timing control unit configured to control a reset timing of charges accumulated in the pixels on the second line in the non-exposure period of the pixels on the second line.

2. The solid-state imaging device according to claim wherein, in the exposure period, a time interval between the read timing and the reset timing of the pixels on the first line is longer than a time interval between the read timing and the reset timing of the pixels on the second line.

3. The solid-state imaging device according to claim 2, wherein a time interval between the read timing of the pixels on the second line in the exposure period and the reset timing of the pixels on the second line in the non-exposure period is equal to a time interval between the read timing of the pixels on the first line in the exposure period and the reset timing of the pixels on the first line in the exposure period.

4. The solid-state imaging device according to claim 2, wherein the reset timing of the pixels on the second line in the non-exposure period is set to a middle of the non-exposure period.

5. The solid-state imaging device according to claim 1, wherein the pixel includes:
a photodiode configured to perform photoelectric conversion;
a read transistor configured to transfer a signal from the photodiode to a floating diffusion based on a read signal;
a reset transistor configured to reset a signal accumulated in the floating diffusion based on a reset signal; and
an amplification transistor configured to detect a potential of the floating diffusion.

6. The solid-state imaging device according to claim 1, wherein the pixels form a Bayer array, and the first line and the second line are alternately set by every two lines.

7. The solid-state imaging device according to claim 1, wherein the image processor includes a synthesis processing unit configured to synthesize an output signal of a long-time exposure obtained from the pixel on the first line, and an output signal of a short-time exposure obtained from the pixel on the second pixel.

8. The solid-state imaging device according to claim 7, wherein the image processor includes a line memory configured to separate output signals output from the pixel array unit with respect to each of exposure periods, and output the output signals in synchronization with a timing of the output signals with respect to each of the exposure periods.

9. The solid-state imaging device according to claim 1, wherein the charge discharge control unit performs discharge control of charges accumulated in the pixels in the non-exposure period of the pixels a plurality of times with respect to each of lines.

10. The solid-state imaging device according to claim 1, wherein, in the pixels on the first line, the charges accumulated in the pixels in the non-exposure period are discharged, and the period changes from the non-exposure period to the exposure period, and
in the pixels on the second line, after the charges accumulated in the pixels in the non-exposure period are discharged and the non-exposure period is maintained, the charges accumulated in the pixels in the non-exposure period are discharged again and the period changes from the non-exposure period to the exposure period.

11. A solid-state imaging device comprising:
a pixel array unit in which pixels configured to accumulate photoelectrically converted charges are arranged in a matrix form;
an exposure period control unit configured to control an exposure period of the pixels with respect to each of lines; and
a charge discharge control unit configured to perform discharge control of charges accumulated in the pixels in a non-exposure period of the pixels with respect to each of the lines.

12. The solid-state imaging device according to claim 11, wherein the exposure period control unit includes:
a read timing control unit configured to control a read timing of charges accumulated in the pixels;
a first exposure-purpose reset timing control unit configured to control a reset timing of charges accumulated in the pixels on the first line; and
a second exposure-purpose reset timing control unit configured to control a reset timing of charges accumulated in the pixels on the second line such that the exposure period is shortened more than the exposure period in the pixels on the first line,
wherein the charge discharge control unit includes an auxiliary reset timing control unit configured to control a reset timing of charges accumulated in the pixels on the second line in the non-exposure period of the pixels on the second line.

13. The solid-state imaging device according to claim 12, wherein, in the exposure period, a time interval between the read timing and the reset timing of the pixels on the first line is longer than a time interval between the read timing and the reset timing of the pixels on the second line.

14. The solid-state imaging device according to claim 13, wherein a time interval between the read timing of the pixels on the second line in the exposure period and the reset timing of the pixels on the second line in the non-exposure period is equal to a time interval between the read timing of the pixels on the first line in the exposure period and the reset timing of the pixels on the first line in the exposure period.

15. The solid-state imaging device according to claim 13, wherein the reset timing of the pixels on the second line in the non-exposure period is set to the middle of the non-exposure period.

16. The solid-state imaging device according to claim 11, wherein the pixel includes:
a photodiode configured to perform photoelectric conversion;
a read transistor configured to transfer a signal from the photodiode to a floating diffusion based on a read signal;
a reset transistor configured to reset a signal accumulated in the floating diffusion based on a reset signal; and
an amplification transistor configured to detect a potential of the floating diffusion.

17. The solid-state imaging device according to claim 16, wherein the pixels form a Bayer array, and the first line and the second line are alternately set by every two lines.

18. The solid-state imaging device according to claim 11, comprising a synthesis processing unit configured to synthesize an output signal of a long-time exposure obtained from the pixel on the first line, and an output signal of a short-time exposure obtained from the pixel on the second pixel.

19. The solid-state imaging device according to claim 18, comprising a line memory configured to separate output signals output from the pixel array unit with respect to each of exposure periods, and output the output signals in synchronization with a timing of the output signals with respect to each of the exposure periods.

20. The solid-state imaging device according to claim 11, wherein the charge discharge control unit performs discharge control of charges accumulated in the pixels in the non-exposure period of the pixels a plurality of times with respect to each of lines.
